(19) United States
(12) Patent Application Publication
(10) Pub. No.: US 2015/0096945 A1
(43) Pub. Date: Apr. 9, 2015

(54) SLURRY-LIQUID SEPARATOR FILTER AND FILTRATION METHOD USING THE SAME

(71) Applicant: SUNSHINE KAIDI NEW ENERGY GROUP CO., LTD., Wuhan (CN)

(72) Inventors: Yilong CHEN, Wuhan (CN); Jiaqi JIN, Wuhan (CN); Yanfeng ZHANG, Wuhan (CN); Manyi JIANG, Wuhan (CN)

(21) Appl. No.: 14/571,252

(22) Filed: Dec. 15, 2014

Related U.S. Application Data
(63) Continuation-in-part of application No. PCT/CN2013/074684, filed on Apr. 25, 2013.

(30) Foreign Application Priority Data
Jun. 29, 2012 (CN) 201210221911.8

(51) Int. Cl. B01D 33/21; B01D 33/50

(52) U.S. Cl. CPC B01D 33/21; B01D 33/50
USPC 210/780; 210/330

(57) ABSTRACT

A slurry-liquid separator filter, including: a filter cylinder body, a filter pipe disposed in the filter cylinder body and a filter core disposed on the filter pipe, a material inlet disposed on the filter cylinder body, a solid residue outlet disposed at the bottom part of the filter cylinder body, and a filtrate outlet disposed at the middle-lower part of the filter cylinder body. The filter core includes a plurality of filter disks connected to the filter pipe, and the filter disks are perpendicular to the longitudinal axis of the filter cylinder body. The upper end of the filter pipe is connected to the rotational axis of a variable-frequency motor. The top part of the filter cylinder body and a transmission shaft of the variable-frequency motor are sealed through high pressure hard sealing.

### CROSS-REFERENCE TO RELATED APPLICATIONS

This application is a continuation-in-part of International Patent Application No. PCT/CN2013/074684 with an international filing date of Apr. 25, 2013, designating the United States, now pending, and further claims priority benefits to Chinese Patent Application No. 201210221911.8 filed Jun. 29, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a dynamic slurry-liquid separator filter and a filtration method using the same.

2. Description of the Related Art

Noble metals such as platinum, palladium, rhodium, silver, and ruthenium, have high catalytic activities and excellent high temperature resistance, oxidation resistance, and corrosion resistance. However, the noble metals are expensive, which greatly restricts the application thereof.

Conventional technologies for recycling noble metal catalysts include distillation, an outer filter method, and an inter filter method. However, the involved reactor is often expensive. The filtration accuracy is low, the heavy distillate still contains many catalysts, and the waste catalyst in the reactor cannot be recycled, resulting in product loss. The returning route of the catalyst and the filter are often blocked, thereby affecting the normal operation of the reactor. In addition, improper operation easily destroys the filter cloth.

### SUMMARY OF THE INVENTION

It is one objective of the invention to provide a high-efficiency dynamic slurry-liquid separator filter and a filtration method using the same. The high-efficiency dynamic slurry-liquid separator filter is beneficial to separating a liquid-solid two-phase (or gas-liquid-solid three-phase) slurry under a relatively high temperature and a relatively high pressure, and particularly solves the recovery of the noble metal waste catalysts from the slurry, which provides possibility for the regeneration and the recovery of the waste catalysts, practically lowers the production cost of the noble metal catalysts, and therefore promotes the wide application of the noble metal catalysts. In addition, the separator filter and the method of the invention also effectively solves the separation of any liquid-solid two-phase (or gas-liquid-solid three-phase) slurry and ensures the quality of the products.

To achieve the above objective, in accordance with one embodiment of the invention, there is provided a slurry-liquid separator filter, comprising: a filter cylinder body, a filter pipe disposed in the filter cylinder body and a filter core disposed on the filter pipe, a material inlet disposed on the filter cylinder body, a solid residue outlet disposed at a bottom part of the filter cylinder body, and a filtrate outlet disposed at a middle-lower part of the filter cylinder body. The filter core comprises a plurality of filter disks connected to the filter pipe, and the filter disks are perpendicular to a longitudinal axis of the filter cylinder body. An upper end of the filter pipe is connected to a rotational axis of a variable-frequency motor. A top part of the filter cylinder body and a transmission shaft of the variable-frequency motor are sealed through high pressure hard sealing. A lower part of the filter pipe is connected to a pipe of the filtrate outlet via a connecting pipe joint. The connecting pipe joint and the pipe of the filtrate outlet are perpendicularly fixed together. An upper opening of the connecting pipe joint and a rotational connection part of the lower part of the filter pipe are sealed through high-pressure hard sealing. A lower part of the connecting pipe joint is sealed.

In a class of this embodiment, each filter disk separately communicates with the filter pipe; the filter disks and the filter pipe form groove connection. The filter disk is fixed on a grooved plate for collecting a filtrate. The filter disk and the grooved plate form a sealed cavity, and a pipe opening at an inner side of the sealed cavity communicates with an inner cavity of the filter pipe. The grooved plate is connected to the filter pipe via a clamp. The collected filtrate from each grooved plate is accumulated in the filter pipe.

In a class of this embodiment, the filter disks are sintered porous metal materials having a pore size distribution of between 15 and 160 μm, a thickness of between 1 and 3 mm, and a working temperature range of between −200 and 800° C. An upper surface of each filter disk is coated with a nanoscale surface agent.

In a class of this embodiment, the bottom part of the filter cylinder body is in a conical structure. An outer wall of the filter cylinder body is provided with an insulation jacket layer. A vapor inlet is disposed at a middle-upper part of the filter cylinder body for communicating with the insulation jacket layer.

In a class of this embodiment, a straight cylinder body and an upper part head of the filter cylinder body are connected by a flange.

In a class of this embodiment, a height of the material inlet is higher than a height of the filtrate outlet by H1 being between 200 and 700 mm A distance between the filtrate outlet and the bottom is H2 being between 400 and 700 mm

In a class of this embodiment, the lower part of the filter cylinder body is provided with a remaining material outlet by H3 being between 200 and 300 mm. A condensate outlet is disposed between the filtrate outlet and the solid residue outlet. A ventilation opening is disposed on an upper part of the filter cylinder body.

In a class of this embodiment, a straight cylinder body and an upper part head of the filter cylinder body are connected by a flange.

A method for separating a slurry-liquid mixture comprises:
1) preheating a separator filter, adding materials to a slurry cavity of a filter body from a material inlet and to reach filter plates; controlling a rotational speed of the filter plates at a range of between 10 and 100 rpm; separating a solid filter residue from the materials on the filter plates, and allowing a filtrate to flow from the filter disks into a pipe of a filtrate outlet via a flow passage of the filter disk, and discharging the filtrate out of the separator filter;

2) continuing the filtration and allowing a filter cake of the filter residues to accumulate on the filter disk to reach a certain thickness until an inside-outside pressure difference of a filter pipe reaches 2.0 MPa; increasing the rotational speed of a motor driving the filter disk to between 100 and 300 rpm so as to remove the filter cake of the filter residues from the filter disk; when the filter cake of the filter residues is removed from the filter disk and the inside-outside pressure difference is less than 50 kPa, controlling the rotational speed of the motor driving the filter disk within a range of between 10 and 100 rpm, maintaining normal filtering operation;

3) when the filtering operation is finished or the filter residues in the bottom part of the filter needs to be discharged, stopping filtering, removing the filter residues for preparation of a next filtration process; and

4) when the filter disk needs to be cleaned, starting a backblow system, stopping the materials from entering the slurry cavity of the filter body, enabling the filtrate outlet to serve as a backblow medium inlet, the backblow medium being a filtrate supernatant or a diesel oil; carrying out backblow operation on the filtrate disk using the backblow medium; controlling the filtrate disk to operate at a rotational speed of between 10 and 100 rpm; and continuing the filtering operation after the backblow operation.

In a class of this embodiment, the slurry cavity of the filter cylinder body has a working temperature of between 200 and 400° C. and a working pressure of between 3.0 and 5.0 MPa (G).

Advantages according to embodiments of the invention are as follows: the invention is particularly applicable for the recovery of the filter residues (noble metal waste catalysts). The invention increases the quality and the production of the products and explores a feasible method for recovering the filter residues (noble metal waste catalysts) and ensuring the products quality, thereby promoting the industrial application of the noble metal waste catalysts and realizing the filtration of materials at high temperatures. Compared with low temperature filtration methods, in conditions of adopting hot feeding means in the subsequent processing of the products, the method of the invention does not only improve the filtration effect but also decreases the energy consumption for apparatus cooling and the energy consumption necessitated in the upgrading and heating processes of the products in subsequent processing, thereby largely decreasing a comprehensive energy consumption. Meanwhile, the high pressure filtration is realized, which effectively decreases the energy consumption necessitated by the pressure boosting in the subsequent high pressure processing. The backblow medium of the backblow system adopts the filtrate supernatant, which avoids secondary pollution to the filter materials and does not produce wastewater resulted from the backblow in the conventional filter.

### BRIEF DESCRIPTION OF THE DRAWINGS

FIG. 1 is a structure diagram of a high-efficiency dynamic slurry-liquid separator filter of the invention;

FIG. 2 is a structure diagram showing filter disks of the invention; and

FIG. 3 is a schematic diagram showing a flow pattern of filtration materials on the filter disks.

### DETAILED DESCRIPTION OF THE EMBODIMENTS

For further illustrating the invention, experiments detailing a high-efficiency dynamic slurry-liquid separator filter and a filtration method using the same are described hereinbelow combined with the drawings.

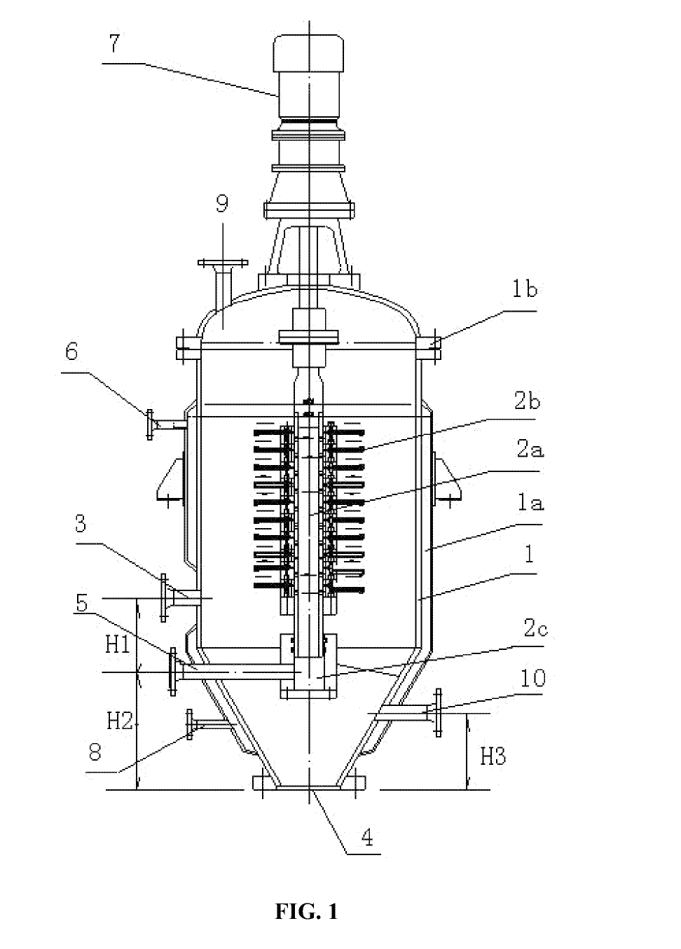

FIG. 1 is a structure diagram of a high-efficiency dynamic slurry-liquid separator filter of the invention.

A high-efficiency dynamic slurry-liquid separator filter comprises: a filter cylinder body 1, a filter pipe 2a disposed in the filter cylinder body 1 and a filter core disposed on the filter pipe 2a, a material inlet 3 disposed on the filter cylinder body 1, a solid residue outlet 4 disposed at a bottom part of the filter cylinder body 1, and a filtrate outlet 5 disposed at a middle-lower part of the filter cylinder body 1. The filter core comprises a plurality of filter disks 2b connected to the filter pipe 2a, and the filter disks 2b are perpendicular to a longitudinal axis of the filter cylinder body 1. An upper end of the filter pipe 2a is connected to a rotational axis of a variable-frequency motor 7. A top part of the filter cylinder body 1 and a transmission shaft of the variable-frequency motor 7 are sealed through high pressure hard sealing. A lower part of the filter pipe 2a is connected to a pipe of the filtrate outlet 5 via a connecting pipe joint 2c. The connecting pipe joint 2c and the pipe of the filtrate outlet are perpendicularly fixed together. An upper opening of the connecting pipe joint 2c and a rotational connection part of the lower part of the filter pipe 2a are sealed through high-pressure hard sealing. A lower part of the connecting pipe joint 2c is sealed.

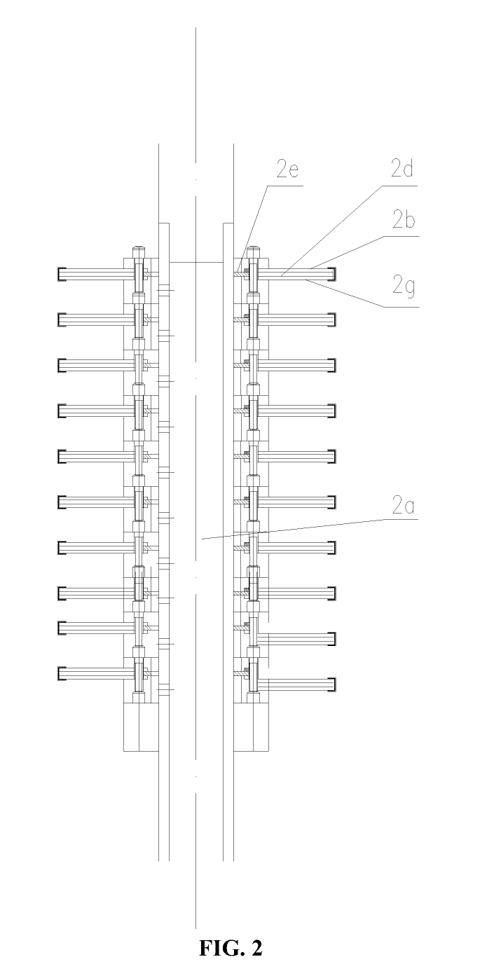

A structure of filter disks is shown in FIG. 2. Each filter disk 2b separately communicates with the filter pipe 2a; the filter disks 2b and the filter pipe 2a form groove connection. The filter disk 2b is fixed on a grooved plate 2g for collecting a filtrate. The filter disk 2b and the grooved plate 2g form a sealed cavity 2d, and a pipe opening 2e at an inner side of the sealed cavity 2d communicates with an inner cavity of the filter pipe 2a. The grooved plate 2g is connected to the filter pipe 2a via a clamp. The collected filtrate from each grooved plate 2g is accumulated in the filter pipe 2a. The filter disks 2b are sintered porous metal materials having a pore size distribution of between 15 and 160 μm, a thickness of between 1 and 3 mm, and a working temperature range of between −200 and 800® C. An upper surface of each filter disk is coated with a nanoscale surface agent. The sintered porous metal materials of the filter disks 2b have different porosities, pore sizes, and pore size distributions, and the arrangement of bore paths entangled into networks. The filter disks 2b have a broad range of adaptable temperature, high-temperature resistance, and thermal shock resistance. In addition, the filter disks are anti-corrosive thereby being adapted to a plurality of corrosive acid or alkali media, and has a high strength and good toughness thereby being applicable to high pressure environment. In addition, the material has stable bore shapes, so that stable filter performance and good renewable performance are ensured. The filter performance can be recovered by 90% after being renewed. The upper surface of the filter disk 2b is coated with a nanoscale surface agent (a thickness of a coating layer of between 10 and 1000 μm) to prevent the filter residue from being attached to the filter disk when using the filter to filter the materials.

The bottom part of the filter cylinder body 1 is in a conical structure. An outer wall of the filter cylinder body 1 is provided with an insulation jacket layer 1a. A vapor inlet 6 is disposed at a middle-upper part of the filter cylinder body 1 for communicating with the insulation jacket layer 1a. An insulation medium in the jacket can be a water vapor, a high pressure hot water, or a conduction oil. The filter adopts the design of the insulation jacket so that the liquid slurry having a large viscosity is filtered at a relatively high temperature and is not attached to the filter when being condensed, thereby ensuring smooth progress of the filter operation.

The bottom part of the filter cylinder body 1 adopts the conical structure. An aperture of the solid residue outlet 4 of the bottom of the filter cylinder body 1 is designed to be relatively large so that it is convenient to clean the filter residue in the bottom part of the filter. An outer wall of the filter cylinder body 1 is provided with an insulation jacket layer 1a.

A height of the material inlet 3 is higher than a height of the filtrate outlet 5 by H1 being between 200 and 700 mm. A distance between the filtrate outlet 5 and the bottom is H2 being between 400 and 700 mm. The height of the material inlet 3 herein is designed to be higher than that of the material inlet of a common filter, so that a viscous liquid having a relatively high solid content can smoothly enter the body of the filter and is prevented from blockage in the bottom of the filter.

A straight cylinder body and an upper part head of the filter cylinder body 1 are connected by a flange 1b.

The lower part of the filter cylinder body is provided with a remaining material outlet 10. A height of the remaining material outlet 10 is higher than a height of the solid residue outlet 4 by H3 being between 200 and 300 mm When malfunction of the filter occurs or when the filtering process is accomplished, incompletely filtrated materials can be discharged from the remaining material outlet 10 so as to ensure production safety. A condensate outlet 8 is disposed between the filtrate outlet 5 and the solid residue outlet 4. A ventilation opening 9 is disposed on an upper part of the filter cylinder body 1.

The slurry cavity of the filter cylinder body has a temperature of between 200 and 400° C. and a pressure of between 3.0 and 5.0 MPa (G).

A high-efficiency dynamic slurry-liquid filtration method comprises: introducing an insulation medium (vapor, high temperature hot water, or conduction oil) into a filter cylinder body to preheat the filter, and maintaining introduction of the insulation medium until the filtering operation is finished.

The method further comprises the following steps:
1) starting filtering operation by a filter after preheating the filter, allowing materials to enter a slurry cavity of a filter body from a material inlet and to reach filter plates; controlling a rotational speed of the filter plates at a range of between 10 and 100 rpm; separating a solid filter residue from the materials on the filter plates, and allowing a filtrate to flow from the filter disks into a pipe of a filtrate outlet via a flow passage of the filter disk so as to discharge the filtrate out of the filter;
2) continuing the filtration for a period, accumulating a filter cake of filter residues on the filter disk to reach a certain thickness until an inside-outside pressure difference reaches 2.0 MPa; increasing the rotational speed of a motor driving rotation of the filter disk to between 100 and 300 rpm so as to remove the filter cake of the filter residues from the filter disk; when the removal of the filter cake of the filter residues from the filter disk is finished and the inside-outside pressure difference is controlled at 50 KPa below, controlling the rotational speed of the motor driving the rotation of the filter disk within a range of between 10 and 100 rpm again, maintaining normal filtering operation, and repeating the above process;
3) when the filtering operation is finished or the filter residues in the bottom part of the filter needs to be discharge, stopping filtering, removing the filter residues for preparation of a next filtration process; and
4) when the filter disk needs to be cleaned, starting a backblow system, stopping the materials from entering the slurry cavity of the filter body, enabling the filtrate outlet to serve as a backblow medium inlet; selecting the backblow medium from a filtrate supernatant or a diesel oil; carrying out backblow operation on the filtrate disk using the backblow medium; controlling the filtrate disk to operate at a rotational speed of between 10 and 100 rpm; and continuing the filtering operation after the backblow operation.

The backblow medium is the filtrate supernatant which will neither result in secondary pollution in the materials nor produce any waste water.

The processes are repeated as described in the above and the filtration will not be stopped until the filtration is accomplished or the filter residue in the bottom of the filter is required to be discharged. The filter residue is removed in timely for the preparation of the next filtration.

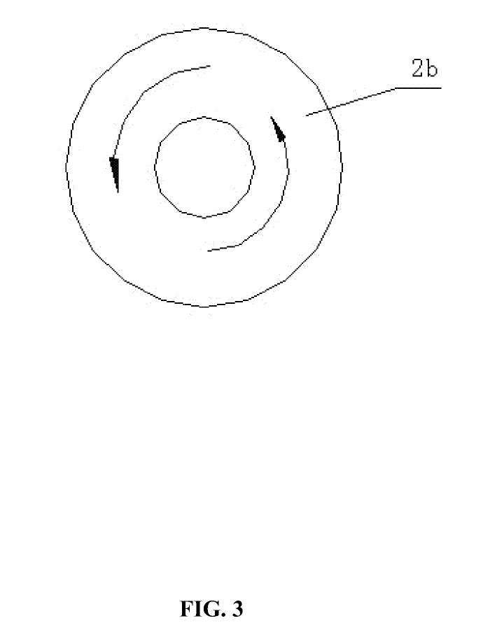

The variable-frequency motor is adopted herein by the invention so as to realize the direct and dynamic filtration. The principle of the direct dynamic filtration (also called thin layer of filter cake filtration or restricted filter cake filtration) is different the conventional filter cake filtration in that the dynamic filtration enables the materials to flow in parallel with a surface of the filtration medium (as shown in FIGS. 1, 3) so that the solid particles are not prone to accumulate on the surface of the filtration medium, thereby maintaining at a relative high filtration speed. The dynamic filtration is the filtration process alternating between filtration in the presence of the filtration cake and filtration in the absence of the filtration cake. The most fundamental purpose of the dynamic filtration is that the formation of the filtration cake is prevented or only a thin layer of filtration cake is formed during the filtration process so as to prevent the enlargement of a filtration resistance and the decrease of the filtration rate resulted from the thickening of the filtration cake. The direct dynamic filtration method makes the filter applicable for long period removal and purification of large quantities of particles.

The filter cylinder body 1 of the invention adopts a fully sealed structure. During the rotation of the filtration disk 2b and the filter pipe 2a, the pipe of the filtrate outlet 5 is fixed and immovable. The connecting part between the filter pipe and the pipe of the filtrate outlet adopts hard sealing and is sealed using a high pressure sealing ring (O-type ring), which therefore effectively solves the rotation sealing problem and achieves zero-leakage. The straight cylinder body and the upper part head of the filtrate cylinder body 1 are connected by the flange 1b which is easy to be disassembled, so that it is convenient for repair and replacement of the filtration components.

The slurry cavity of the filter cylinder body has a temperature of between 200 and 400° C. and a pressure of between 3.0 and 5.0 Mpa (G). The filtration accuracy is controlled between 1 and 25 μm. The separator filter of the invention is adapted to intermittent filtration operation. The materials needing to be filtrated are filtrated by the specialized filter, the filter residues are accumulated at the outlet of the conical bottom part of the filter; when the filter residues reach a certain thickness, the filtration operation is stopped; a valve disposed at the outlet of the conical bottom part of the filter is then opened to discharge the filter residue (solid noble metal catalyst), thereby providing possibility for further recovering of the filter residue. The filtrate product after the filtration contains a part of solid impurities of small particles (possessing a grain size of 5 um below), that is, the noble metal spent catalyst, which can be introduced into another filter apparatus having a higher filtration accuracy for carrying out a next step of refined filtration treatment if necessary.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A slurry-liquid separator filter, comprising:
1) a filter cylinder body;
2) a filter pipe, the filter pipe being disposed in the filter cylinder body;
3) a filter core, the filter core being disposed on the filter pipe;
4) a material inlet, the material inlet being disposed on the filter cylinder body;
5) a solid residue outlet, the solid residue outlet being disposed at a bottom part of the filter cylinder body; and
6) a filtrate outlet, the filtrate outlet being disposed at a middle-lower part of the filter cylinder body;
wherein
the filter core comprises a plurality of filter disks connected to the filter pipe, and the filter disks are perpendicular to a longitudinal axis of the filter cylinder body;
an upper end of the filter pipe is connected to a rotational axis of a variable-frequency motor; a top part of the filter cylinder body and a transmission shaft of the variable-frequency motor are sealed through high pressure hard sealing; and
a lower part of the filter pipe is connected to a pipe of the filtrate outlet via a connecting pipe joint; the connecting pipe joint and the pipe of the filtrate outlet are perpendicularly fixed together; an upper opening of the connecting pipe joint and a rotational connection part of the lower part of the filter pipe are sealed through high-pressure hard sealing; and a lower part of the connecting pipe joint is sealed.

2. The separator filter of claim 1, wherein
each filter disk separately communicates with the filter pipe; the filter disks and the filter pipe form groove connection;
the filter disk is fixed on a grooved plate for collecting a filtrate;
the filter disk and the grooved plate form a sealed cavity, and a pipe opening at an inner side of the sealed cavity communicates with an inner cavity of the filter pipe;
the grooved plate is connected to the filter pipe via a clamp; and
the collected filtrate from each grooved plate is accumulated in the filter pipe.

3. The separator filter claim 2, wherein
the filter disks are sintered porous metal materials having a pore size distribution of between 15 and 160 μm, a thickness of between 1 and 3 mm, and a working temperature range of between −200 and 800® C.; and
an upper surface of each filter disk is coated with a nanoscale surface agent.

4. The separator filter claim 2, wherein the bottom part of the filter cylinder body is in a conical structure; an outer wall of the filter cylinder body is provided with an insulation jacket layer; and a vapor inlet is disposed at a middle-upper part of the filter cylinder body for communicating with the insulation jacket layer.

5. The separator filter claim 2, wherein a straight cylinder body and an upper part head of the filter cylinder body are connected by a flange.

6. The separator filter claim 2, wherein a height of the material inlet is higher than a height of the filtrate outlet by H1 being between 200 and 700 mm; and a distance between the filtrate outlet and the bottom is H2 being between 400 and 700 mm.

7. The separator filter claim 2, wherein
the lower part of the filter cylinder body is provided with a remaining material outlet;
a height of the remaining material outlet is higher than a height of the solid residue outlet by H3 being between 200 and 300 mm;
a condensate outlet is disposed between the filtrate outlet and the solid residue outlet; and
a ventilation opening is disposed on an upper part of the filter cylinder body.

8. The separator filter claim 3, wherein a straight cylinder body and an upper part head of the filter cylinder body are connected by a flange.

9. A method for separating a slurry-liquid mixture, the method comprising:
1) preheating a separator filter, adding materials to a slurry cavity of a filter body from a material inlet and to reach filter plates; controlling a rotational speed of the filter plates at a range of between 10 and 100 rpm; separating a solid filter residue from the materials on the filter plates, and allowing a filtrate to flow from the filter disks into a pipe of a filtrate outlet via a flow passage of the filter disk, and discharging the filtrate out of the separator filter;
2) continuing the filtration and allowing a filter cake of the filter residues to accumulate on the filter disk to reach a certain thickness until an inside-outside pressure difference of a filter pipe reaches 2.0 MPa; increasing the rotational speed of a motor driving the filter disk to between 100 and 300 rpm so as to remove the filter cake of the filter residues from the filter disk; when the filter cake of the filter residues is removed from the filter disk and the inside-outside pressure difference is less than 50 kPa, controlling the rotational speed of the motor driving the filter disk within a range of between 10 and 100 rpm, maintaining normal filtering operation;
3) when the filtering operation is finished or the filter residues in the bottom part of the filter needs to be discharged, stopping filtering, removing the filter residues for preparation of a next filtration process; and
4) when the filter disk needs to be cleaned, starting a backblow system, stopping the materials from entering the slurry cavity of the filter body, enabling the filtrate outlet to serve as a backblow medium inlet, the backblow medium being a filtrate supernatant or a diesel oil; carrying out backblow operation on the filtrate disk using the backblow medium; controlling the filtrate disk to operate at a rotational speed of between 10 and 100 rpm; and continuing the filtering operation after the backblow operation.

10. The method of claim 9, wherein the slurry cavity of the filter cylinder body has a working temperature of between 200 and 400° C. and a working pressure of between 3.0 and 5.0 MPa (G).
